(19) United States
(12) Patent Application Publication
(10) Pub. No.: US 2007/0159020 A1
(43) Pub. Date: Jul. 12, 2007

(54) Water pump and bearing thereof

(75) Inventors: Hou-Chu Chen, Taoyuan Hsien (TW); Shui-Fa Tsai, Taoyuan Hsien (TW); Chin-Chu Hsu, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/448,817

(22) Filed: Jun. 8, 2006

(30) Foreign Application Priority Data
Jan. 11, 2006 (TW) 095101004

(51) Int. Cl. H02K 7/00; H02K 5/12; H02K 5/16

(52) U.S. Cl. 310/90; 417/423.12; 310/67 R; 310/87

(57) ABSTRACT

A bearing of a water pump is adapted to be used with a washer and includes an approximately cylindrical body with an axial hole defined in its center. One end surface of the bearing, which faces the washer, has a nick for forming a water membrane so as to reduce friction and adhesion between the bearing and the washer.

### BACKGROUND OF THE INVENTION

1. Field of Invention

The invention relates to a water pump and a bearing thereof, and, in particular, to a water pump capable of reducing the friction force by a bearing thereof.

2. Related Art

FIG. 1 is a schematic view of a conventional water pump. FIG. 2A is a top view of a bearing of the water pump, and FIG. 2B is a sectional view of the bearing. Referring to FIGS. 1, 2A and 2B, the water pump 1 mainly includes a rotor structure 11, a stator structure 12, a central axle 13, and a frame 14 for covering the stator structure 12. The rotor structure 11 includes a bearing 111, a magnetic body 112 and a plurality of blades 113. The bearing 111 has an axial hole 1111 for allowing the central axle 13 to penetrate therethrough. The top surface 1112 of the bearing 111 is ring-shaped as shown in FIG. 2A. The bearing 111 and the magnetic body 112 are connected by insertion molding. The stator structure 12 mainly includes a stator base 121 and a magnetic pole set 122 located on the stator base 121. The blades 113 are disposed on the top of the magnetic body 112. By changing the polarity of the magnetic pole set 122, the rotor structure 11 of the water pump 1 can be driven to rotate.

However, when the water pump 1 starts working, the rotor structure 11 tends to float upwards. To solve this problem, a ring-shaped washer 15 is used to rub against the bearing 111. To enhance the durability and lifetime of the washer 15 and bearing 111, the top surface 1112 of the bearing 111 and a corresponding surface of the washer 15 facing the bearing are both smooth surfaces so as to reduce the friction and wear.

Nevertheless, since the top surface 1112 of the bearing 111 and the corresponding surface of the washer 15 are both smooth surfaces, the adhesion phenomenon therebetween becomes serious, which thus increases the friction force between the bearing 111 and the washer 15. Therefore, the performance of the water pump 1 is not as good as expected.

Therefore, it is an important subject of the invention to provide a water pump and a bearing thereof for solving the above-mentioned problems.

### SUMMARY OF THE INVENTION

In view of the foregoing, the invention is to provide a water pump and a bearing thereof, which can prevent the adhesion phenomenon between the bearing and a washer to reduce the friction and wear therebetween, thereby enhancing the performance of the water pump and prolonging the lifetime of the bearing.

To achieve the above, a bearing of a water pump of the invention, which is cooperated with a washer, includes an approximately cylindrical body with an axial hole defined in a center of the body. An end surface of the body facing the washer has a nick for forming a water membrane.

To achieve the above, a water pump of the invention includes a washer, a central axle, a rotor structure and a stator structure. In the invention, the rotor structure includes a bearing and a magnetic body. The bearing has an axial hole defined in a center thereof, and an end surface of the bearing, which faces the washer, has a nick for forming a water membrane. The magnetic body is disposed around the bearing, and is preferably disposed annularly around the bearing without covering the nick. The stator structure includes a stator base and a magnetic pole set. The stator base is disposed at one side of the rotor structure. The magnetic pole set is located on the stator base and corresponding to the magnetic body.

As mentioned above, the invention provides a nick on an end surface of the bearing facing the washer for preventing the end surface of the bearing from adhering to the washer. Therefore, the friction and wear between the end surface and the washer can be decreased, so that the performance of the water pump is enhanced and the lifetime of the bearing is prolonged.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional water pump;

FIG. 2A is a top view of a bearing of the conventional water pump;

FIG. 2B is a sectional view of the bearing of the conventional water pump;

FIG. 3 is a schematic view of a water pump according to a preferred embodiment of the invention;

FIG. 4A is a schematic view of a rotor structure of the water pump of FIG. 3;

FIG. 4B is a top view of a bearing according to the embodiment of the invention;

FIG. 4C is a schematic view showing the rotated bearing of FIG. 4B; and

FIGS. 5A to 5D are schematic views showing the bearing with different nicks according to other embodiments of the invention.

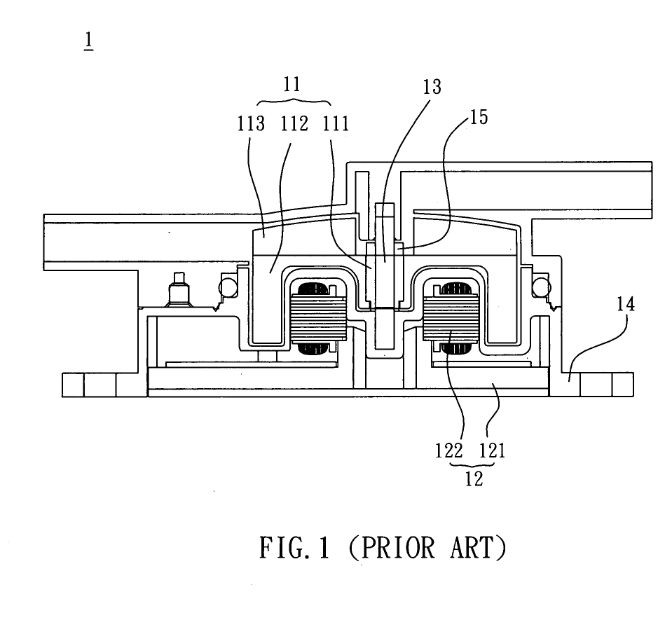

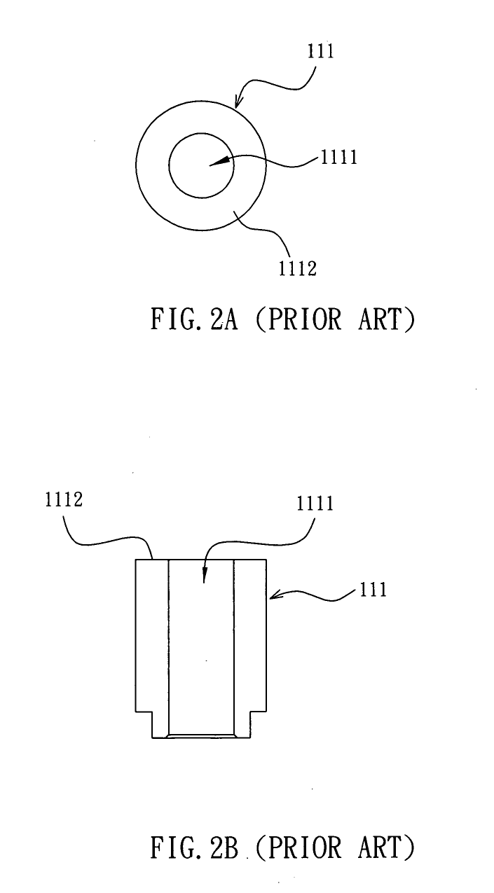

### DETAILED DESCRIPTION OF THE INVENTION

The present invention will be apparent from the following detailed description, which proceeds with reference to the accompanying drawings, wherein the same references relate to the same elements.

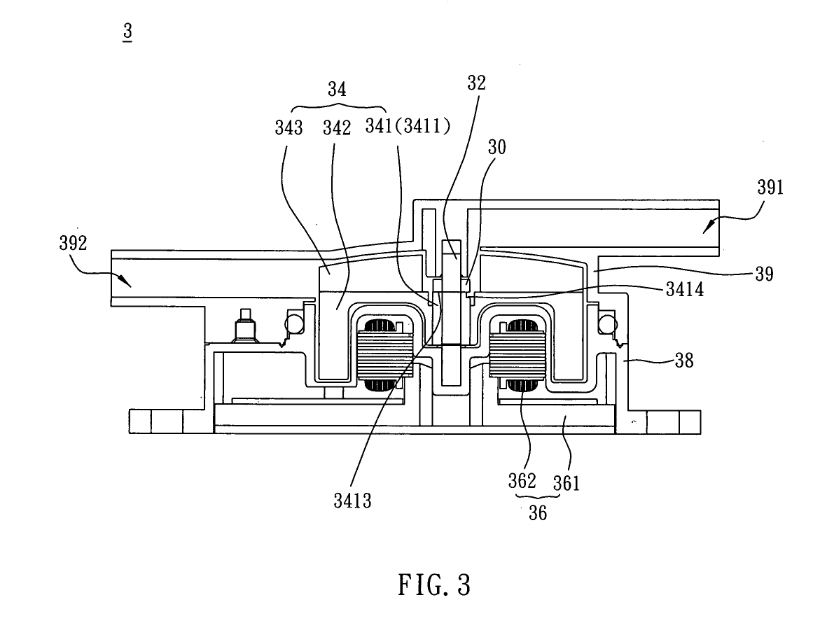

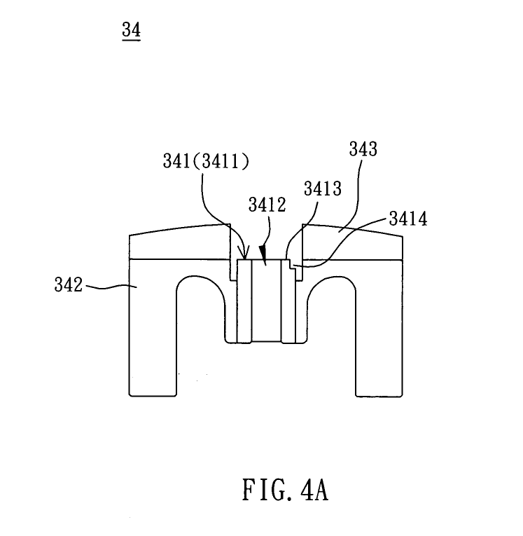

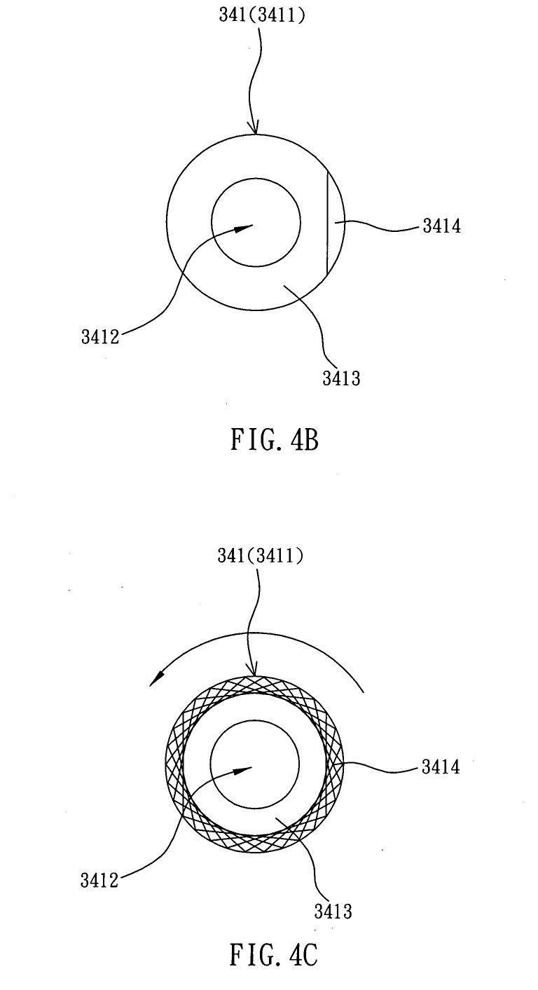

FIG. 3 is a schematic view of a water pump according to a preferred embodiment of the invention. FIG. 4A is a schematic view of a rotor structure of the water pump of FIG. 3. FIG. 4B is a top view of a bearing according to the embodiment of the invention. FIG. 4C is a schematic view showing the rotated bearing of FIG. 4B. With reference to FIGS. 3 and 4A to 4C, a water pump 3 includes a washer 30, a central axle 32, a rotor structure 34, a stator structure 36, and a frame 38 for covering the stator structure 36.

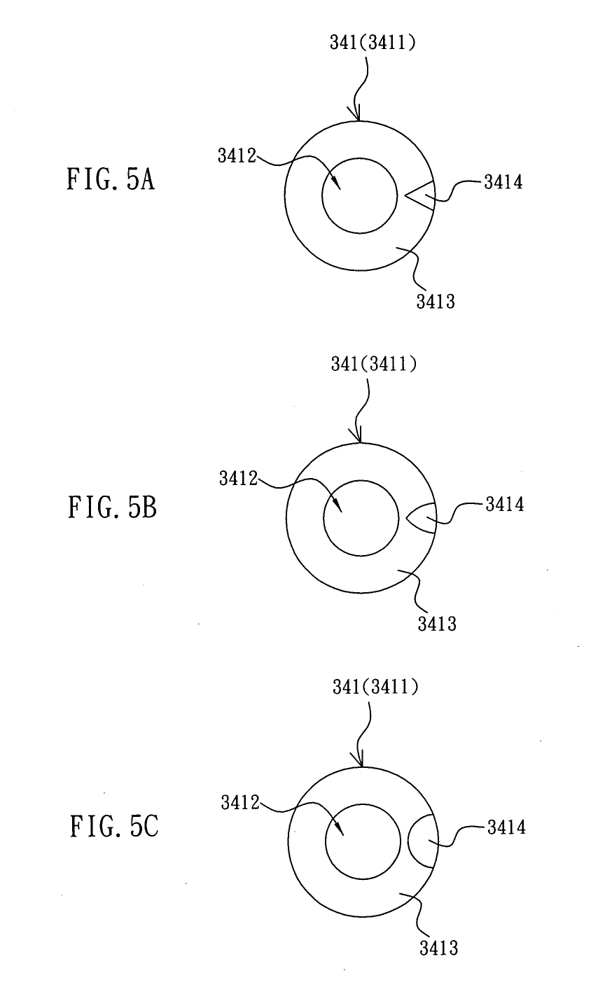

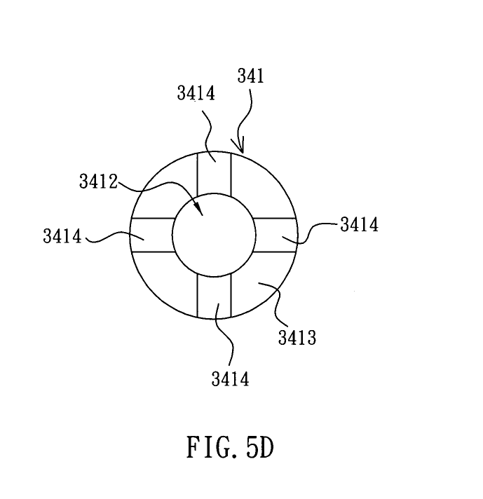

As shown in FIG. 4A, the rotor structure 34 includes a bearing 341, a magnetic body 342, and a plurality of blades 343 which are disposed on a top surface of the magnetic body 342. The bearing 341 has an approximately cylindrical body 3411 made of ceramics. The body 3411 has an axial hole 3412 defined in a center thereof, and the central axle 32 passes through the axial hole 3412. An end surface 3413 of the body 3411, which faces the washer 30, is a smooth surface and has a nick 3414 located at its rim (as shown in FIG. 4B). In this case, the nick 3414 is in a D shape. Of course, the nick 3414 can be in a sector shape as shown in FIG. 5A, a half-olive shape as shown in FIG. 5B, an arc shape as shown in FIG. 5C, or any other irregular shapes. Besides, although this embodiment discloses only one nick 3414, the end surface 3413 can also have several nicks as shown in FIG. 5D which illustrates cross-shaped nicks. In practice, the number of the nicks depends on the actual needs.

The washer 30 is ring-shaped and is made of ceramics. In the embodiment, the washer 30 is disposed around the central axle 32 and corresponding to the end surface 3413 of the body 3411. A surface of the washer 30 facing the end surface 3413 is substantially a smooth surface.

Referring to FIG. 4A again, the magnetic body 342 is disposed around the body 3411 and is apart from the nick 3414 at a predetermined distance. That is, the magnetic body 342 does not cover the nick 3414. The magnetic body 342 can be made of any kinds of magnetic material.

The magnetic body 342 and the body 3411 are connected by insertion molding. Because of the different material characteristics of the magnetic body 342 and the body 3411, water prefers adhering to the surface of the magnetic body 342. Additionally, when the water pump 3 starts working, a water membrane will be formed on the end surface 3413 of the body 3411 by the rotation of the nick 3414 as shown in FIG. 4C, which can prevent the adhesion phenomenon between the body 3411 and the washer 30. Accordingly, the friction and wear between the body 3411 and the washer 30 can be reduced so as to enhance the performance of the water pump 1 and prolong the lifetime of the bearing 341 and the washer 30.

Referring back to FIG. 3, the stator structure 36 includes a stator base 361 and a magnetic pole set 362. The magnetic pole set 362 is located on the stator base 361 and corresponding to the magnetic body 342. The stator base 361 can be made of plastics or nonmagnetic rigid material such as metal or alloy. The magnetic pole set 362 is composed of silicon steel sheets and a winding for driving the rotor structure 34 to rotate.

The water pump 3 further includes an upper cover 39, which is assembled with the frame 38. The upper cover 39 includes a water inlet 391 and a water outlet 392. The water inlet 391 and the water outlet 392 are communicated with each other. When the water pump 3 starts working, water enters the rotor structure 34 through the water inlet 391, and is pushed out of the water pump 3 through the water outlet 392 by the force generated by the rotated blades 343. In the embodiment, the frame 38 completely covers the stator structure 36, so that water can not enter the stator structure 36.

In summary, the invention provides a nick on an end surface of the bearing facing the washer for preventing adhesion phenomenon between the washer and the bearing. Therefore, the friction and wear between the end surface and the washer can be decreased, so that the performance of the water pump is enhanced and the lifetime of the bearing and washer is prolonged.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A bearing, which is cooperated with a washer, comprising an approximately cylindrical body with an axial hole defined therein, wherein an end surface of the body facing the washer has a nick.

2. The bearing of claim 1, wherein the nick is located at a rim of the end surface.

3. The bearing of claim 1, wherein the end surface of the body and a surface of the washer facing the end surface of the body are substantially smooth surfaces.

4. The bearing of claim 1, wherein the body is made of ceramics.

5. The bearing of claim 1, wherein the nick is in a D shape, a sector shape, a half-olive shape, an arc shape, a cross shape or an irregular shape.

6. The bearing of claim 1, wherein the washer is a ring-shaped washer.

7. The bearing of claim 1, wherein the washer is made of ceramics.

8. A water pump comprising:
a washer;
an axle penetrating the washer;
a rotor structure comprising a bearing and a magnetic body, wherein the magnetic body is disposed around the bearing, and the bearing has an axial hole defined therein for allowing the axle to penetrate therethrough and an end surface which faces the washer and has a nick thereon; and
a stator structure comprising a stator base and a magnetic pole set, wherein the magnetic pole set is mounted on the stator base to interact with the magnetic body.

9. The water pump of claim 8, wherein the rotor structure further comprises a plurality of blades disposed on a top surface of the magnetic body.

10. The water pump of claim 8, wherein the magnetic body and the bearing are formed by insertion molding.

11. The water pump of claim 8, wherein the nick is located at a rim of the end surface.

12. The water pump of claim 8, wherein the end surface of the bearing and a surface of the washer facing the end surface of the body are substantially smooth surfaces.

13. The water pump of claim 8, wherein the bearing is made of ceramics.

14. The water pump of claim 8, wherein the nick is in a D shape, a sector shape, a half-olive shape, an arc shape, a cross shape or an irregular shape.

15. The water pump of claim 8, wherein the washer is a ring-shaped washer.

16. The water pump of claim 8, wherein the washer is made of ceramics.

17. The water pump of claim 8, further comprising a frame for covering the stator structure.

18. The water pump of claim 17, further comprising an upper cover assembling with the frame.

19. The water pump of claim 18, wherein the upper cover comprises a water inlet and a water outlet communicated with each other.

20. The water pump of claim 8, wherein the magnetic body is apart from the nick at a predetermined distance.
